(19) United States
(12) Patent Application Publication
(10) Pub. No.: US 2017/0268418 A1
(43) Pub. Date: Sep. 21, 2017

(54) Electromagnetic Motor Enhancement System

(71) Applicant: Elliot Gamble, Denver, CO (US)

(72) Inventor: Elliot Gamble, Denver, CO (US)

(21) Appl. No.: 15/070,370

(22) Filed: Mar. 15, 2016

(51) Int. Cl. F02B 65/00; H02K 33/16; F02F 1/24; H02K 7/075; F02P 9/00; F02F 3/00

(52) U.S. Cl. CPC F02B 65/00; F02P 9/00; F02F 3/0084; F02F 1/24; H02K 7/075; H02K 33/16

(57) ABSTRACT

A electromagnetic motor enhancement system includes an internal combustion engine that has a plurality of pistons, at least one cylinder head and an ignition control module. Each of the pistons is selectively urged in an upstroke and a downstroke. A plurality of magnets is provided and each of the magnets is coupled to an associated one of the pistons. An electromagnetic unit is coupled to the internal combustion engine. The electromagnetic unit is electrically charged in a first polarity when the pistons are urged in the upstroke. Thus, the magnet corresponding to each of the pistons is attracted to the electromagnet unit. The electromagnetic unit is electrically charged in a second polarity when the pistons are urged in the downstroke. Thus, the magnet corresponding to each of the pistons is repelled from the electromagnetic unit.

### BACKGROUND OF THE DISCLOSURE

### Field of the Disclosure

The disclosure relates to electromagnetic devices and more particularly pertains to a new electromagnetic device for increasing fuel efficiency of an internal combustion engine.

### SUMMARY OF THE DISCLOSURE

An embodiment of the disclosure meets the needs presented above by generally comprising an internal combustion engine that has a plurality of pistons, at least one cylinder head and an ignition control module. Each of the pistons is selectively urged in an upstroke and a downstroke. A plurality of magnets is provided and each of the magnets is coupled to an associated one of the pistons. An electromagnetic unit is coupled to the internal combustion engine. The electromagnetic unit is electrically charged in a first polarity when the pistons are urged in the upstroke. Thus, the magnet corresponding to each of the pistons is attracted to the electromagnet unit. The electromagnetic unit is electrically charged in a second polarity when the pistons are urged in the downstroke. Thus, the magnet corresponding to each of the pistons is repelled from the electromagnetic unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a electromagnetic motor enhancement system according to an embodiment of the disclosure.

FIG. 2 is a front cut-away view of a piston an embodiment of the disclosure in an upstroke.

FIG. 3 is a front cu-away view of a piston of an embodiment of the disclosure in a downstroke.

FIG. 4 is a cross sectional view taken along line 4-4 of FIG. 3 of an embodiment of the disclosure.

FIG. 5 is a schematic view of an embodiment of the disclosure.

### DESCRIPTION OF THE PREFERRED EMBODIMENT

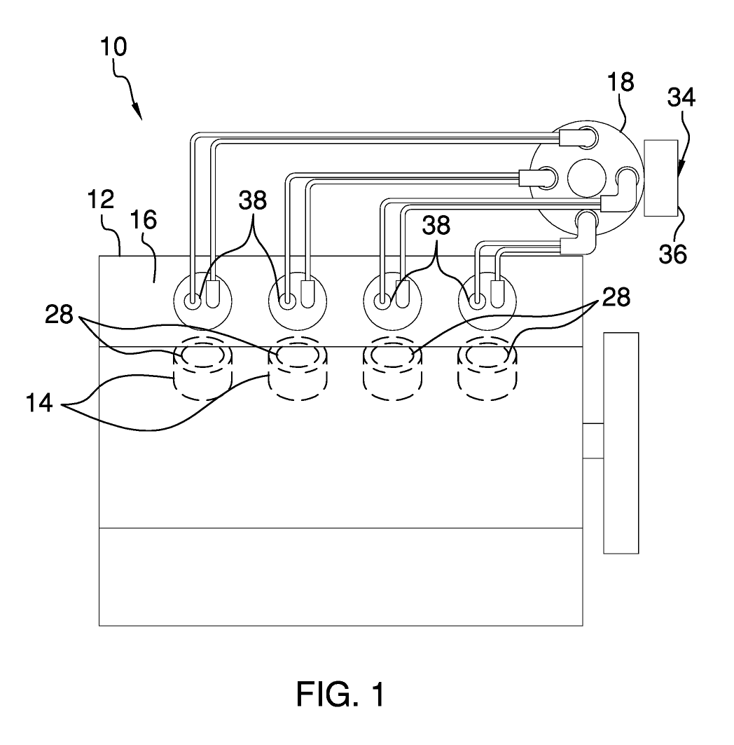

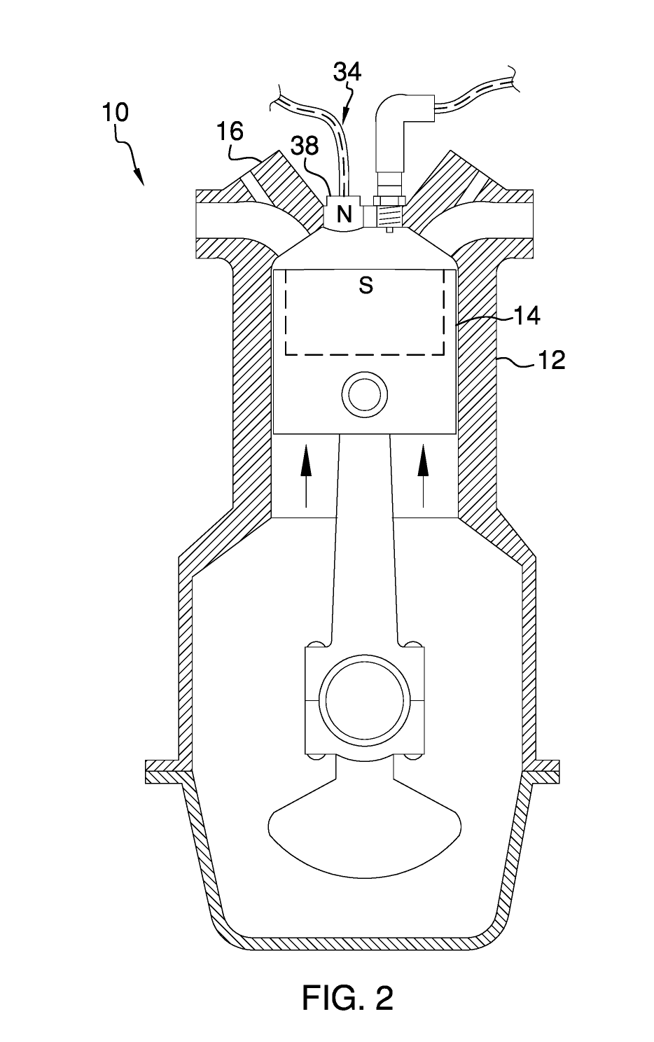

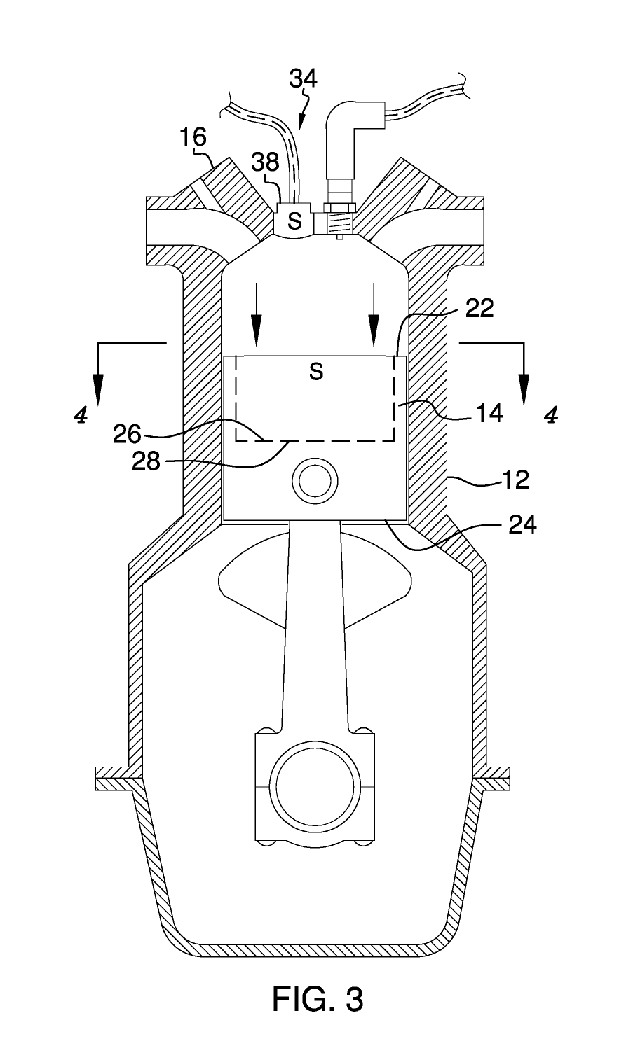

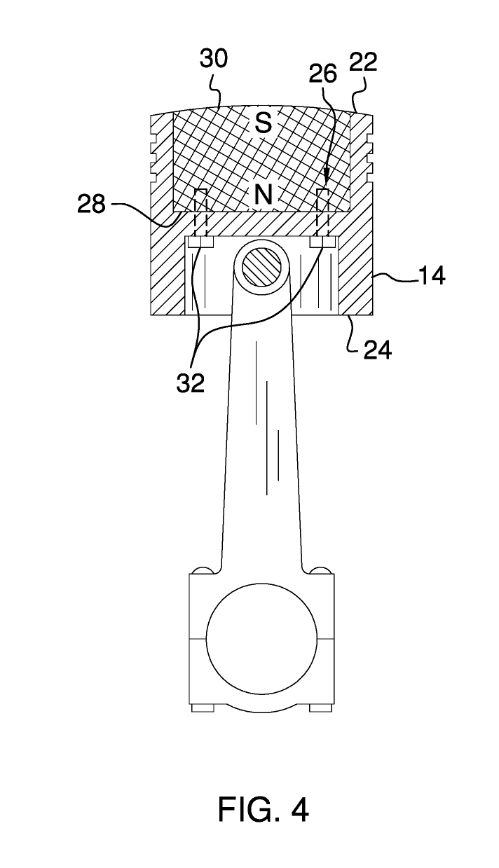

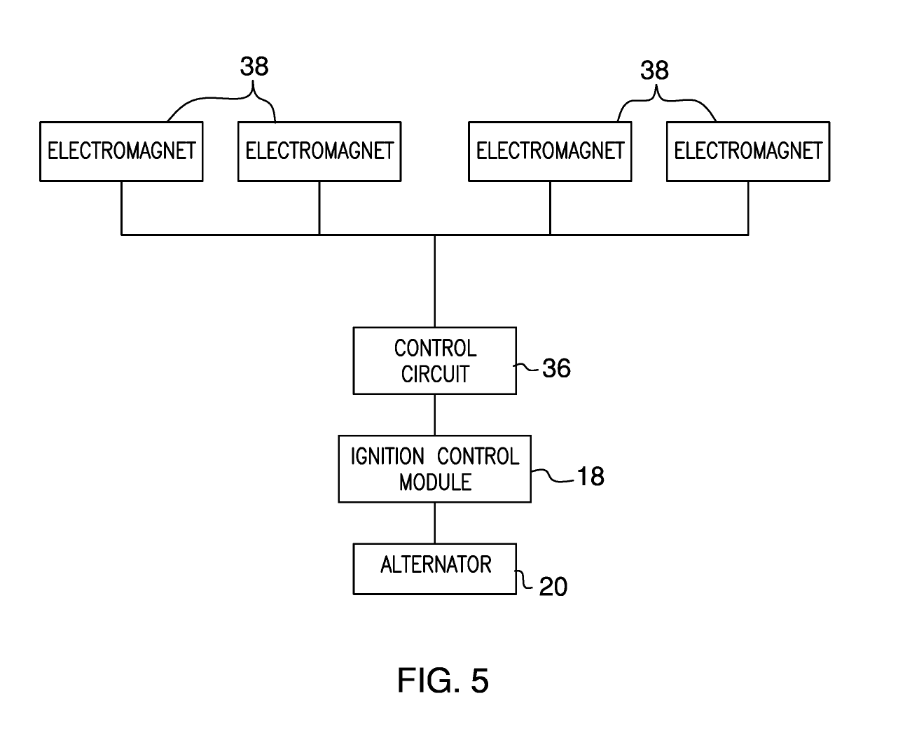

With reference now to the drawings, and in particular to FIGS. 1 through 5 thereof, a new electromagnetic device embodying the principles and concepts of an embodiment of the disclosure and generally designated by the reference numeral 10 will be described.

As best illustrated in FIGS. 1 through 5, the electromagnetic motor enhancement system 10 generally comprises an internal combustion engine 12 that has a plurality of pistons 14, at least one cylinder head 16, an ignition control module 18 and an alternator 20. Each of the pistons 14 has a top end 22 and a bottom end 24. The top end 22 corresponding to each of the pistons 14 has a well 26 extending downwardly therein. Each of the pistons 14 is selectively urged in an upstroke and a downstroke. The internal combustion engine 12 may be any internal combustion engine involving pistons and a crankshaft. The ignition control module 18 may comprise a distributor, an electronic ignition control module or any ignition control module 18 used to control an ignition sequence of the internal combustion engine 12.

A plurality of magnets 28 is provided and each of the magnets 28 is coupled to an associated one of the pistons 14. Each of the magnets 28 has a top surface 30. Each of the magnets 28 is positioned in the well 26 corresponding to the associated piston 14. The top surface 30 corresponding to each of the magnets 28 is aligned with the top end 22 corresponding to the associated piston 14.

A plurality of bolts 32 is provided. Each of the bolts 32 extends upwardly through the bottom end 24 of an associated one of the pistons 14. The bolts 32 engage the magnet 28 in the associated piston 14. Thus, each of the magnets 28 is retained in the associated piston 14.

An electromagnetic unit 34 is provided. The electromagnetic unit 34 is coupled to the internal combustion engine 12. The electromagnetic unit 34 is electrically coupled to the ignition control module 18. The ignition control module 18 is electrically coupled to the alternator 20. Thus, the electromagnet unit 34 is in electrical communication with the alternator 20. The electromagnetic unit 34 is in electromagnetic communication with each of the magnets 28.

The electromagnetic unit 34 is electrically charged in a first polarity when the pistons 14 are urged in the upstroke. The magnet 28 corresponding to each of the pistons 14 is attracted to the electromagnet unit 34 when the electromagnetic unit 34 is charged in the first polarity. Thus, the electromagnetic unit 34 contributes momentum to the motion of the piston 14 in the upstroke. The electromagnetic unit 34 is electrically charged in a second polarity when the pistons 14 are urged in the downstroke. Thus, the magnet 28 corresponding to each of the pistons 14 is repelled from the electromagnetic unit 34 when the electromagnetic unit 34 is charged in the second polarity. The electromagnetic unit 34 enhances fuel efficiency of the internal combustion engine 12 by adding electromagnetic energy to the energy released through fuel combustion.

The electromagnetic unit 34 comprises a control circuit 36 that is coupled to the internal combustion engine 12. The control circuit 36 is electrically coupled to the ignition control module 18. The control circuit 36 may be positioned within a housing. The housing may be coupled to the internal combustion engine 12.

A plurality of electromagnets 38 is provided and each of the electromagnets 38 is coupled to the cylinder head 16. Each of the electromagnets 38 is aligned with an associated one of pistons 14. Each of the electromagnets 38 extends through the cylinder head 16. Thus, each of the electromagnets 38 is exposed with respect to the top end 22 corresponding to the associated piston 14.

Each of the electromagnets 38 is electrically coupled to the control circuit 36. Each of the electromagnets 38 is electrically charged in the first polarity when the associated piston 14 is urged in the upstroke. Thus, the magnet 28 in the associated piston 14 is attracted to an associated electromagnet 38. Each of the electromagnets 38 is electrically charged in the second polarity when the associated piston 14 is urged in the downstroke. Thus, the magnet 28 in the associated piston 14 is repelled from the associated electromagnet 38.

In use, the internal combustion engine 12 is manufactured with the electromagnetic unit 34 as an integral component of the internal combustion engine 12. Alternatively, the electromagnetic unit 34 is retrofitted onto an existing internal combustion engine 12. Each of the electromagnets 38 is charged in the first polarity when the associated piston 14 is urged in the upstroke. Thus, each of the electromagnets 38 imparts momentum into the associated piston 14 on the upstroke. Each of the electromagnets 38 is charged in the second polarity when the associated piston 14 is urged in the downstroke. Thus, each of the electromagnets 38 imparts momentum into the associated piston 14 on the downstroke. The electromagnetic unit 38 increases fuel efficiency of the internal combustion engine 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electromagnetic motor enhancement system comprising:
an internal combustion engine having a plurality of pistons, at least one cylinder head and an ignition control module, each of said pistons being selectively urged in an upstroke and a downstroke;
a plurality of magnets, each of said magnets being coupled to an associated one of said pistons; and
a electromagnetic unit being coupled to said internal combustion engine, said electromagnetic unit being electrically coupled to said ignition control module, said electromagnetic unit being in communication with each of said magnets, said electromagnetic unit being electrically charged in a first polarity when said pistons are urged in said upstroke such that said magnet corresponding to each of said pistons is attracted to said electromagnet unit wherein said electromagnetic unit is configured to enhance efficiency of said internal combustion engine, said electromagnetic unit being electrically charged in a second polarity when said pistons are urged in said downstroke such that said magnet corresponding to each of said pistons is repelled from said electromagnetic unit.

2. The system according to claim 1, wherein:
each of said pistons has a top end, said top end corresponding to each of said pistons having a well extending downwardly therein; and
each of said magnets having a top surface, each of said magnets being positioned in said well corresponding to said associated piston, said top surface corresponding to each of said magnets being aligned with said top end corresponding to said associated piston.

3. The system according to claim 1, wherein said electromagnetic unit comprises a control circuit being coupled to said internal combustion engine, said control circuit being electrically coupled to said ignition control module.

4. The system according to claim 3, further comprising a plurality of electromagnets, each of said electromagnets being coupled to said cylinder head, each of said electromagnets being aligned with an associated one of pistons, each of said electromagnets extending through said cylinder head such that each of said electromagnets is exposed with respect to a top end corresponding to said associated piston, each of said electromagnets being electrically coupled to said control circuit.

5. The system according to claim 3, wherein each of said electromagnets is electrically charged in said first polarity when said associated piston is urged in said upstroke such that said magnet in said associated piston is attracted to an associated electromagnet.

6. The system according to claim 3, wherein each of said electromagnets is electrically charged in said second polarity when said associated piston is urged in said downstroke such that said magnet in said associated piston is repelled from said associated electromagnet.

7. An electromagnetic motor enhancement system comprising:
an internal combustion engine having a plurality of pistons, at least one cylinder head and an ignition control module, each of said pistons having a top end, said top end corresponding to each of said pistons having a well extending downwardly therein, each of said pistons being selectively urged in an upstroke and a downstroke; and
a plurality of magnets, each of said magnets being coupled to an associated one of said pistons, each of said magnets having a top surface, each of said magnets being positioned in said well corresponding to said associated piston, said top surface corresponding to each of said magnets being aligned with said top end corresponding to said associated piston; and
a electromagnetic unit being coupled to said internal combustion engine, said electromagnetic unit being electrically coupled to said ignition control module, said electromagnetic unit being in communication with each of said magnets, said electromagnetic unit being electrically charged in a first polarity when said pistons are urged in said upstroke such that said magnet corresponding to each of said pistons is attracted to said electromagnet unit wherein said electromagnetic unit is configured to enhance efficiency of said internal combustion engine, said electromagnetic unit being electrically charged in a second polarity when said pistons are urged in said downstroke such that said magnet corresponding to each of said pistons is repelled from said electromagnetic unit, said electromagnetic unit comprising:
a control circuit being coupled to said internal combustion engine, said control circuit being electrically coupled to said ignition control module,
a plurality of electromagnets, each of said electromagnets being coupled to said cylinder head, each of said electromagnets being aligned with an associated one of pistons, each of said electromagnets extending through said cylinder head such that each of said electromagnets is exposed with respect to said top end corresponding to said associated piston, each of said electromagnets being electrically coupled to said control circuit, each of said electromagnets being electrically charged in said first polarity when said associated piston is urged in said upstroke such that said magnet in said associated piston is attracted to an associated electromagnet, each of said electromagnets being electrically charged in said second polarity when said associated piston is urged in said downstroke such that said magnet in said associated piston is repelled from said associated electromagnet.
